(19) United States
(12) Patent Application Publication
(10) Pub. No.: US 2008/0065237 A1
(43) Pub. Date: Mar. 13, 2008

(54) Dynamic HTML based Multi Tabbed Sortable Results

(76) Inventor: Wesley V. Long, Bonnyville (CA)

Correspondence Address: FURR LAW FIRM, 2622 DEBOLT ROAD, UTICA, OH, 43080, US

(21) Appl. No.: 11/530,478

(22) Filed: Sep. 10, 2006

(51) Int. Cl. G05B 19/18

(52) U.S. Cl. 700/3

(57) ABSTRACT

The current invention is a next generation search engine. It has been designed to be an extension of current standard search systems. It is an internet search in which multiple searches can be conducted simultaneously using both keywords and function triggers with each set of results displaying in their own tab. The tabs are contained within the web (HTML) page itself. Each tab of results can be quickly flipped through for viewing and comparison then closed individually or all at once.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of operation for attaining education via communication of two or more parties.

2. Background

It only takes one keyword search on any major search engine to get a glimpse of the complete disarray of results. Duplicate links, irrelevant content and spoof sites plaque this generation of search engine. Simply put the amount of content being indexed has our grown current systems and these major search companies continue to focus their efforts on complex algorithms to filter and relate combinations of keywords and phrases.

Those who are frequently online searching for information, services and/or products for what ever reason, it is increasingly becoming more frustrating for users, to find quality, relevant results. More often than not they have to filter through a good number of sites before we actually find what we are looking for if we find it at all. This is not necessarily a new problem. This problem has only gotten bigger.

The fundamental function of how search engines index and list web sites and page results has hardly even changed. Sure some complex specialized algorithms have been developed in an attempt to increase the quality of the results. Pay-Per-Click, Pay-Per-Position, Sponsored Links and Content Network Affiliate Programs have always and still are all based on the budget of the advertiser and not the quality, relevance or popularity of the content. These programs are often exploited by organized and unorganized fraudulent activities like click fraud. While it is hard to imagine one have speculated could be the downfall of the search giants if something isn't done.

Another problem is the value for the advertiser. In any of the current systems being ranked or listed in the top 10 can be expensive, time consuming and when a 2% conversion rate is considered very good it is obvious there a real lack in actual value to advertisers.

There exists a need to get better results. There is still room for improvement in the art.

### SUMMARY OF THE INVENTION

The current invention is a next generation search engine with a completely unique and different model to achieve the best, most relevant search results. It has been designed to be an extension of current standard search systems. It is an internet search in which multiple searches can be conducted simultaneously using both keywords and function triggers with each set of results displaying in their own tab. The tabs are contained within the web (HTML) page itself. Each tab of results can be quickly flipped through for viewing and comparison then closed individually or all at once.

The system 1 will allow three search styles. Each style has its use depending on the extent you wish to take your search. These styles are: Standard Results—Standard DMOZ.org results used by all major search engines; System Results—Offers the most relevant results rated by consumers; and Split Results—Displays both results in a split screen format.

The system 1 will use Content Relevance Score (CRS). CRS is an all new from the ground up search result rating and ranking system. The sole purpose of CRS is to filter less relevant results and is largely based on the consumer opinion of result relevance for any given keyword or phrase.

### GLOSSARY OF TERMS

Browser: a software program that runs on a client host and is used to request Web pages and other data from server hosts. This data can be downloaded to the client's disk or displayed on the screen by the browser.
Client host: a computer that requests Web pages from server hosts, and generally communicates through a browser program.
Content provider: a person responsible for providing the information that makes up a collection of Web pages.
Embedded client software programs: software programs that comprise part of a Web site and that get downloaded into, and executed by, the browser.
Cookies: data blocks that are transmitted to a client browser by a web site.
Hit: the event of a browser requesting a single Web component.
Host: a computer that is connected to a network such as the Internet. Every host has a hostname (e.g., mypc.mycompany.com) and a numeric IP address (e.g., 123.104.35.12).
HTML (HyperText Markup Language): the language used to author Web Pages. In its raw form, HTML looks like normal text, interspersed with formatting commands. A browser's primary function is to read and render HTML.
HTTP (HyperText Transfer Protocol): protocol used between a browser and a Web server to exchange Web pages and other data over the Internet.
HyperText: text annotated with links to other Web pages (e.g., HTML).
IP (Internet Protocol): the communication protocol governing the Internet.
Server host: a computer on the Internet that hands out Web pages through a Web server program.
URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.
UWU server: in connection with the present invention, a special Web server in charge of distributing statistics describing Web traffic.
Visit: a series of requests to a fixed Web server by a single person (through a browser), occurring contiguously in time.
Web master: the (typically, technically trained) person in charge of keeping a host server and Web server program running.
Web page: multimedia information on a Web site. A Web page is typically an HTML document comprising other Web components, such as images.
Web server: a software program running on a server host, for handing out Web pages.
Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows the results of a search;

FIG. 3 displays the content relevance scoring screen;

FIG. 4 displays sample search strings;

FIG. 5 displays First Term Repeater Functions;

FIG. 6 displays Last Term Repeater Functions;

FIG. 7 displays a keyword search for a Feed Sources Search;

FIG. 8 displays a Tabbed Feed Reader;

FIG. 9 displays multi-tabs;

FIG. 10 displays slider bar;

FIG. 11 displays the new tabs;

FIG. 12 display screens for Bulk searches and Repeater Searches;

FIG. 13 displays Independent Tabs and Place Holding; and

FIG. 14 displays a search string example.

### BRIEF DESCRIPTION OF THE PREFERRED EMBODIMENTS

There are a number of significant design features and improvements incorporated within the invention.

The present invention relates to system 1 that is an Internet Search Engine. The System 1 is an internet search tool in which multiple searches can be conducted simultaneously using both keywords and function triggers with each set of results displaying in their own tab. The tabs are contained within the web (HTML) page itself. Each tab of results can be quickly flipped through for viewing and comparison then closed individually or all at once.

The system 1 promotes and targets more effectively. Knowing if people see your site or page as relevant to their search can be a major factor in determining which keywords and phrases will produce the best results across all major search engines.

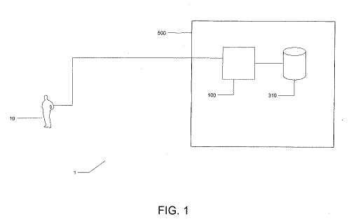

FIG. 1 illustrates a functional diagram of a computer network for World Wide Web 500 access to the System 1 from a plurality of Users 10 who accesses the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each player 10 will have a display device such as a monitor and input device like a keyboard. This display and input device can even be a PDA like a Blackburn.

The Users 10 contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System 1. The system 1 will have a database 310 for the storing of data and code.

Output can include a screen, a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 for both embodiments includes computer processing means for processing data, storage means for storing data on a storage medium, and communication means for transferring data in a secure environment.

For the first embodiment on the Windows.™. version, the data is entered on remote work stations and stored in local databases until the user performs a data transmission function which electronically transfers the data to a central database. The central database acts as a central repository enabling multiple off-site users to view and/or modify data, and generate reports or output.

For the second embodiment (the web browser version), it can be conceptually broken down into two main components or groupings that allow the data processing system to achieve its functionality. They are as follows: (1) a main database that acts as the central repository for data entered into the system and (2) a means for processing data or computer software means in the form of coded computer instructions.

The user 10 will log on to the system 1 using a username and password using generally accepted username and password rules. This username and password will be unique to the user 10. The users should be using some type of computer system that will allow him or her to hear and communicate verbally to the system 1, such as through a microphone and headset. The user 10 will have a profile section on the system which will store required and informative data about the user 10.

The current invention is a next generation search engine with a completely unique and different model to achieve the best, most relevant search results. It has been designed to be an extension of current standard search systems. The system 1 will have a simple sign up process with email verification. It will collect the following information: Email Address; Password and Confirm Password.

The system 1 will allow three search styles. Each style has its use depending on the extent the User 10 wishes to take their search. These styles are: Standard Results—Standard DMOZ.org results used by all major search engines; Content Relevance Score Results—Offers the most relevant results rated by consumers; and Split Results—Displays both results in a split screen format.

Content Relevance Score (CRS) is a all new from the ground up search result rating and ranking system. The purpose of CRS is to filter less relevant results and is largely based on the consumer opinion of result relevance for any given keyword or phrase. It provides before insight into the mind of a market without sacrificing the privacy of consumers by tracking how many clicks a result has had. CRS is to filters the results so that results are truly in order of most relevant to least. This is largely based on the consumer opinion of result relevance for any given keyword or phrase. It also takes in to account the number of people that have scored.

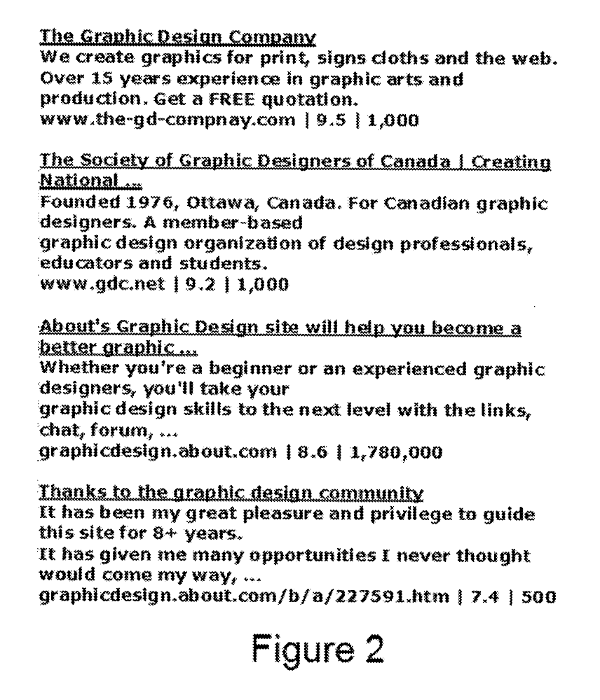

For Example: When a search is done for Graphic Designers in any major search engine it comes back with approx 41 million results. Most are aware that this does not mean there are 41 million designers listed in the results. It means that 41 million pages with the words “Graphic Designers” have been indexed. This includes marketplaces, forums, user groups, resource sites and more. While this can be a useful way to do a number of extensive searches, the mere mass of results makes it almost impossible and very time consuming to pick out the actual Graphic Designers. These results are displayed in FIG. 2.

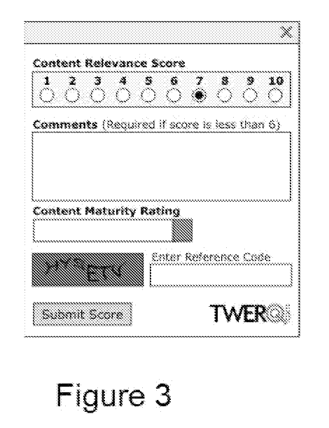

The system 1 offers users free scoring results to improve the over all relevance of results of standard or newly listed System results. The Users 10 will score a search results using a rating system such as the one in FIG. 3. The user 10 rates the results on a content relevance score which in the preferred embodiment is a rating between one and ten with ten being the highest. The user 10 can add a comment in a comment field, give it a content maturity rating and must type it a word that is given in a non-standard printing. The typing of the words is to prevent someone from using a computer to vote using a MOD or computer program to skew the rating results.

The System 1 is set up so that a User can be compensated for time searching the web into a source of revenue. This program is a major part of CRS (Content Relevance Score). Users rate the results based on relevance on a scale from 1 through 10. There are 2 types of result scoring free and paid. Free result scoring is done with both search result styles. Once a result has been rated, it is added and/or displayed in the CRS Results. Paid result scoring is done only with CRS results. Websites and businesses can encourage more Users to score their site's relevance to keywords.

An advertiser or marketer can encourage the system 1 to score their result listing with Pay-Per-Score. Which is paying Users to evaluate and rate the relevance of the result is a way to both market their site or page as well as collect valuable never before available information.

The system 1 will have tabbed search results, which are an innovative and streamlined way to conduct internet searches. It allows users to display multiple results each within their own tab by checking the “New Tab” checkbox along side the search box. Users can then flip through each tab of results to more quickly find or compare results. Tabs can be individually closed or closed all at once. This is similar to tabbed browsers only it is integrated directly into the web interface using PHP, Javascript DHTML and AJAX to dynamically generate the html. Users can open multiple tabs by checking the New Tab check box with there search. Tabs can be individually closed or closed all at once. This makes it more portable for devices which do not have tabbed browsing functionality. It also improves the tabbed browsing experience by keep multiple searches within one tab. The functions include: Auto-Select Text Field where text input field for keywords should be selected to type when page loads; New Tab where the check box is selected results will appear in a new tab; Page Jumps & Navigation with Next and previous buttons along with linked page numbers; Close Tab which will close the selected tab and return the user to the previous selected tab; Close All Tabs which will close all open tabs from the main search bar; Back Tab which will be a link that will select the previous selected tab; and Edit Tab which displays the keyword in the field so that a User 10 can edit their search.

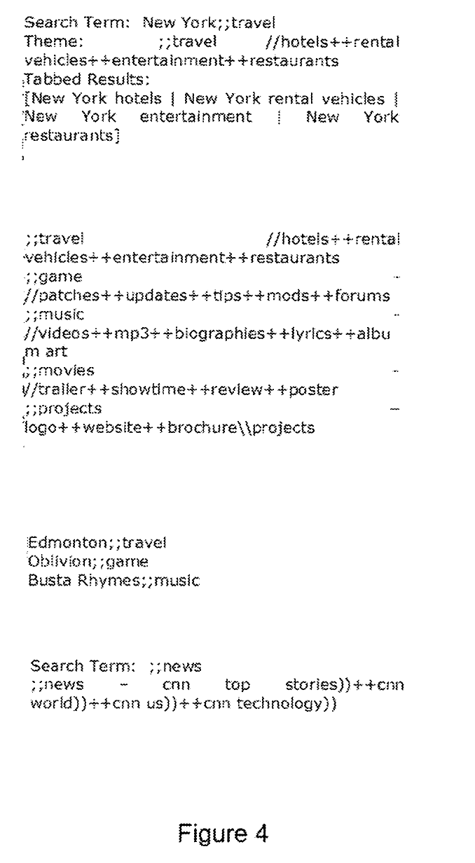

The system 1 will have bulk search capabilities which will allow users to search for more than one keyword or phrase at once by simply using “++” to trigger each search as shown in FIG. 4. Each set of results will open in a new tab and is search simultaneously.

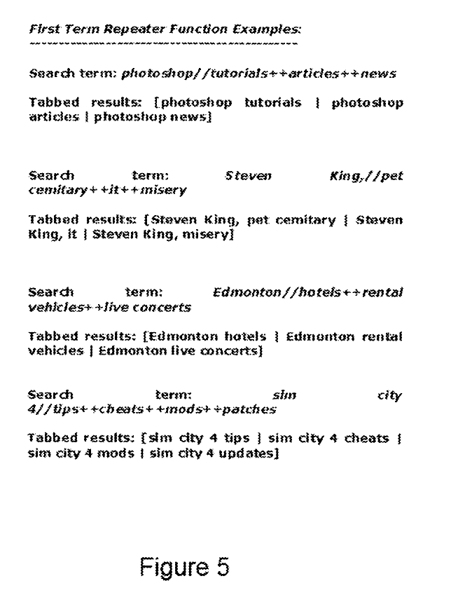

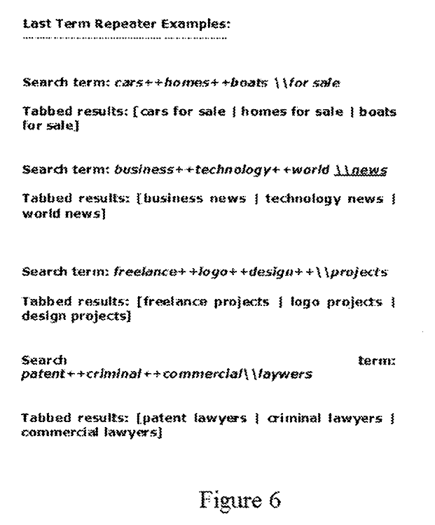

The system 1 will have repeater functions for bulk searching. It enhances searching in countless ways and truly speeds up the search experience. It allows the User 10 to refine their results ahead of time by submitting all the variations of terms at once. An Example is shown First Term Repeater Functions is in FIG. 5 and Last Term Repeater Functions is in FIG. 6.

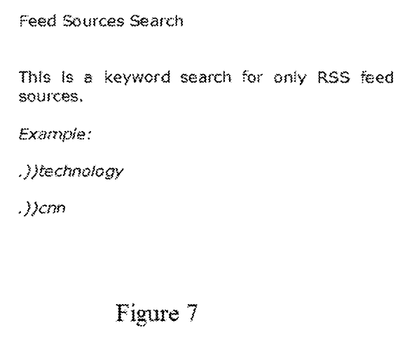

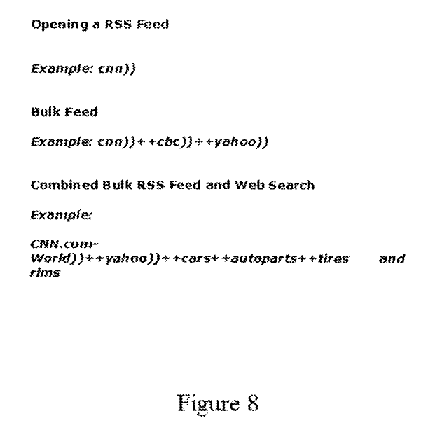

As more and more people use RSS to syndicate content, searching and viewing that content of the system 1 needs to be streamlined. There are two methods of searching RSS content. One method is a Feed Sources Search which is a keyword search for only RSS feed sources. An example is shown in FIG. 7. The system 1 will return tabbed results displaying all the RSS feed sources that are categorized as technology related. The other method is a Tabbed Feed Reader which displays overviews for one or more RSS feeds within internal tabs. An example is shown in FIG. 8.

The system 1 will allow a User 10 to save their search and page position so that they can continue their search another time. Searches can be opened through a listed interface or by typing in the keyword. The results will open in a tab on the same page as it was saved. In the preferred embodiment, the Users 10 must have a System 1 account and be logged in to both save and open results.

The system 1 will allow a User 10 to bookmark a single result so that they can shortlist results or store a specific result to check out a later time. Bookmarks can quickly by access through a menu and can easily be categorized by keyword or custom title. This helps The User 10 organize and even used to track the performance of results for SEO professionals. In the preferred embodiment, the Users 10 must have a system 1 account and be logged in to both save and open results.

The system 1 can be customized and adjusted to match a user's own personal searching preferences. The User 10 can Show/Hide result footer page navigation, Set whether links shown with results should open in the same or a new browser window, Control tab size by choosing a max character amount for the tab label, Set their own preference for number of page jumps to display at once, Increase speed and performance by caching results and information in a session and cookie, Clear cached results, Set personal preference for new tab check box default, and a Session and Cookie management function allows the User to view, adjust, clear or remove all information.

The system 1 will have a Query User Interface which is a control panel for preferences on how the User 10 would like the interface to work. The control panel will include a New Tab function which allows a user 10 to specify whether all searches open in a new tab by default. A Tab order where a User 10 can choose 1-2-3 or 3-2-1 for the order of how the tabs are displayed. A Number of tabs function that sets the max number of tabs to be used. A Page Jumps function that sets how many page numbers the User 10 would like displayed. A Tab Size function that allows the user 10 to determine the number of characters displayed on a tab. An Internal Tab Scrolling function that would enable internal scrolling within the tab and not the browser. An Open Link Options where Users 10 can determine how result links will open, same window or a new one. A Results Footer Search Box that simply displays the same search bar at the bottom of the results. A Tool Tips function that enables and disables the tooltips that appear when a User 10 hovers over a button. An End Session function that will end the session and clear any searches. A Remove Cookie function that will remove the cookie and reset all preferences within these settings. A Refresh Cookie that will removed the cookie and reset all preferences within these settings. A Search Engine Selector which is used to select which search engine to pull results from. The system 1 will start with dmoz & Google Search Engines.

The system 1 will have shortcuts triggers. These shortcuts triggers allows the users 10 to save search strings ahead of time to be used in their day to day search. They are able to name their shortcut so that it may be accessed easily using a trigger and the name of the shortcut. An Example is shown in FIG. 4.

The system 1 will have result shortlists that are single results that a User 10 can add to a list and use to either track for quick reference as well as track SEO performance.

The system 1 will save searches by keyword entered in a list of URLs and page numbers stored in the database. Saved searches can be opened by clicking the open search button on the main search bar. Searches and feeds can be grouped and opened together.

The system 1 will have a toolbar for IE and FF which will be like a remote control for the system's website 100. The websites search bar and logo can be disabled so that more room is available on the page and the user can more easily use the toolbar.

The system 1 will have bulk searches that allows users 10 to search for more than one keyword or phrase at once by simply using “++” to trigger each search. Each set of results will open in a new tab and is search simultaneously. The system 1 will allow Repeater Functions for Bulk Searching which enhances searching in countless ways and truly speeds up the search experience. It allows the User 10 to refine their results ahead of time by submitting all the variations of terms at once.

The system 1 is designed to Pick up where a User 10 left off with a Page Place Holding function. If a User 10 has done lots of searching chances are they may have lost their place once or twice if not more by leaving the site, refining or changing their search. The system's Page Place Holder will automatically return the User to the page of results that the User was last on if they search for the same item again. Should the User 10 leaves the site at any time and come back, the search result tabs and page placements will be as they were when the User 10 left, allowing them to continue their search seamlessly.

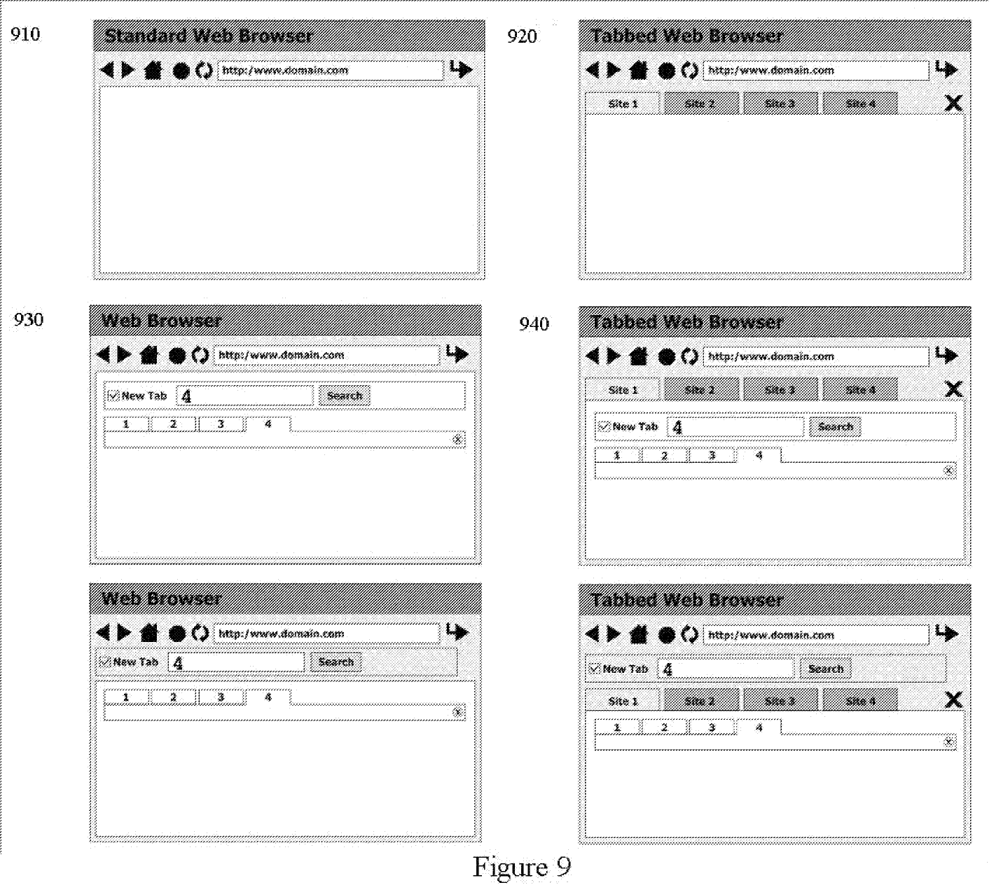

When using the System 1, the first tab is usually the first search. If the “New Tab” checkbox is unchecked editing your search term will change the results of the currently selected tab. (FIG. 9, Diagram 910) If the “New Tab” checkbox is checked, search results with open in new selected tab (FIG. 9, Diagram 920)

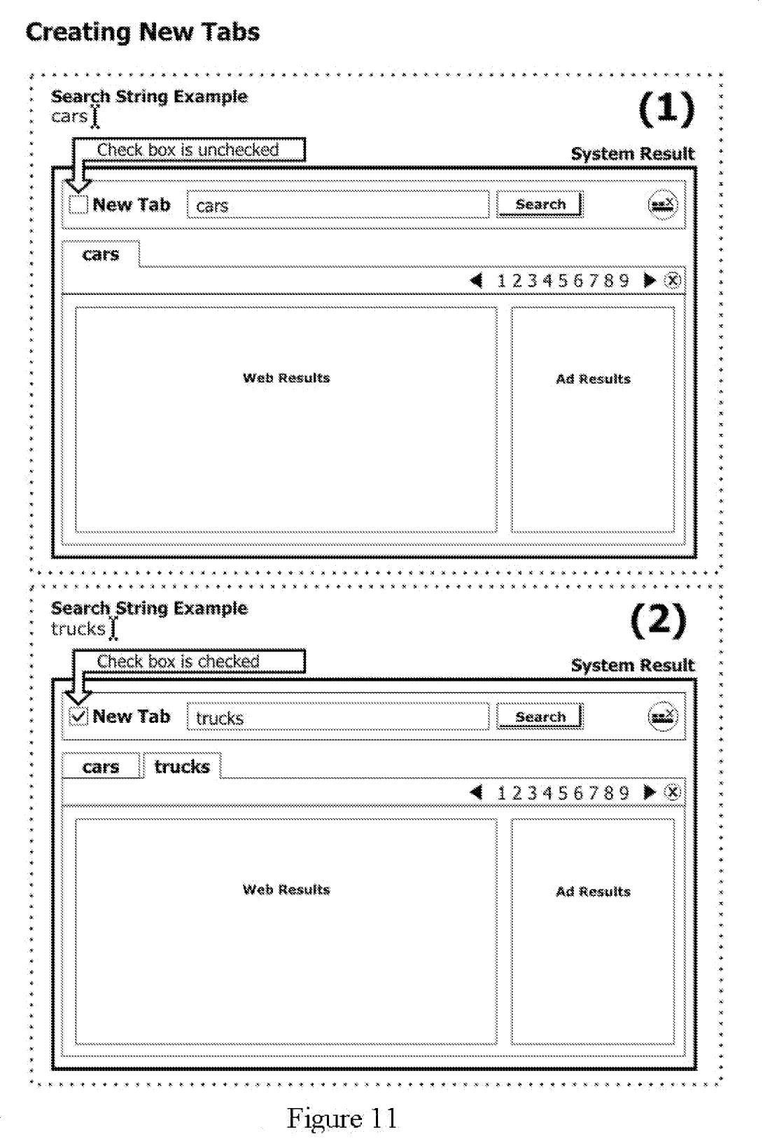

There is no limit to the number of tabs. As new tabs are created the tabs appear horizontally along the top of the bar in the order they were opened as shown in FIG. 11.

Each tab can be independently closed or all tabs at once. If one tab is closed the site will automatically return to the last selected tab of results. (FIG. 9, Diagram 940)

The order in which the tabs are displayed can be changed to group common results closer together for easy comparison. This is done by clicking and holding the left mouse button, dragging the tab to the desired location, and then releasing the left mouse button

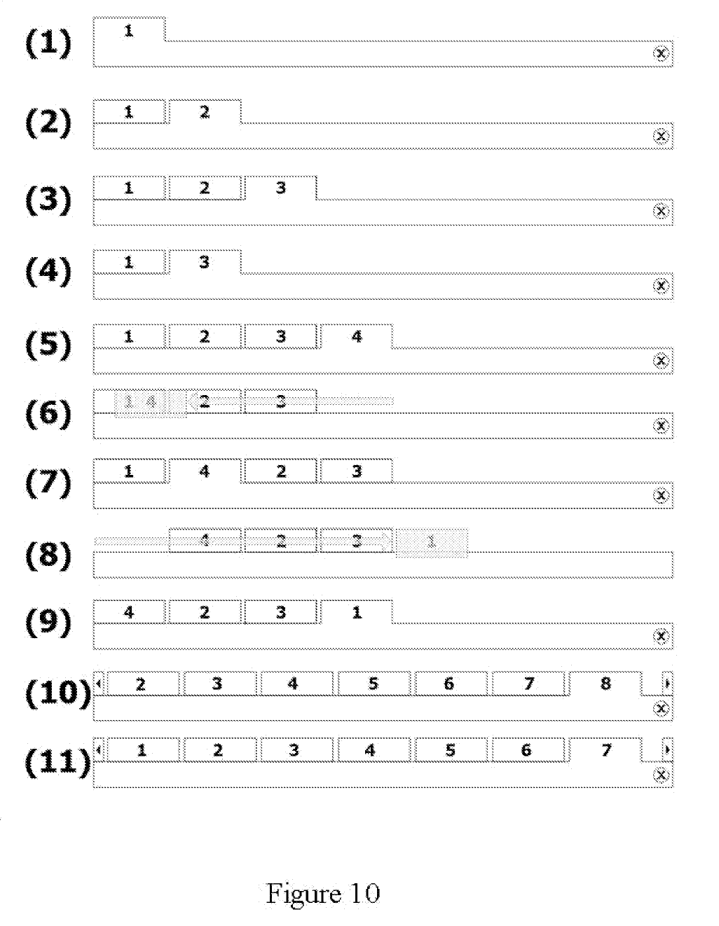

Once the number of open tabs has surpassed 8, side scrollers appear on both sides of the tabs so that you can page through all open tabs as shown in FIG. 10.

Some of the System 1 functions are listed below.

### Function Triggers

Function Triggers are keystrokes that call on a particular function of the system. They can be used together or individually in any number of ways giving the system the ability to match a wide array of search patterns and styles.

### Bulk Search

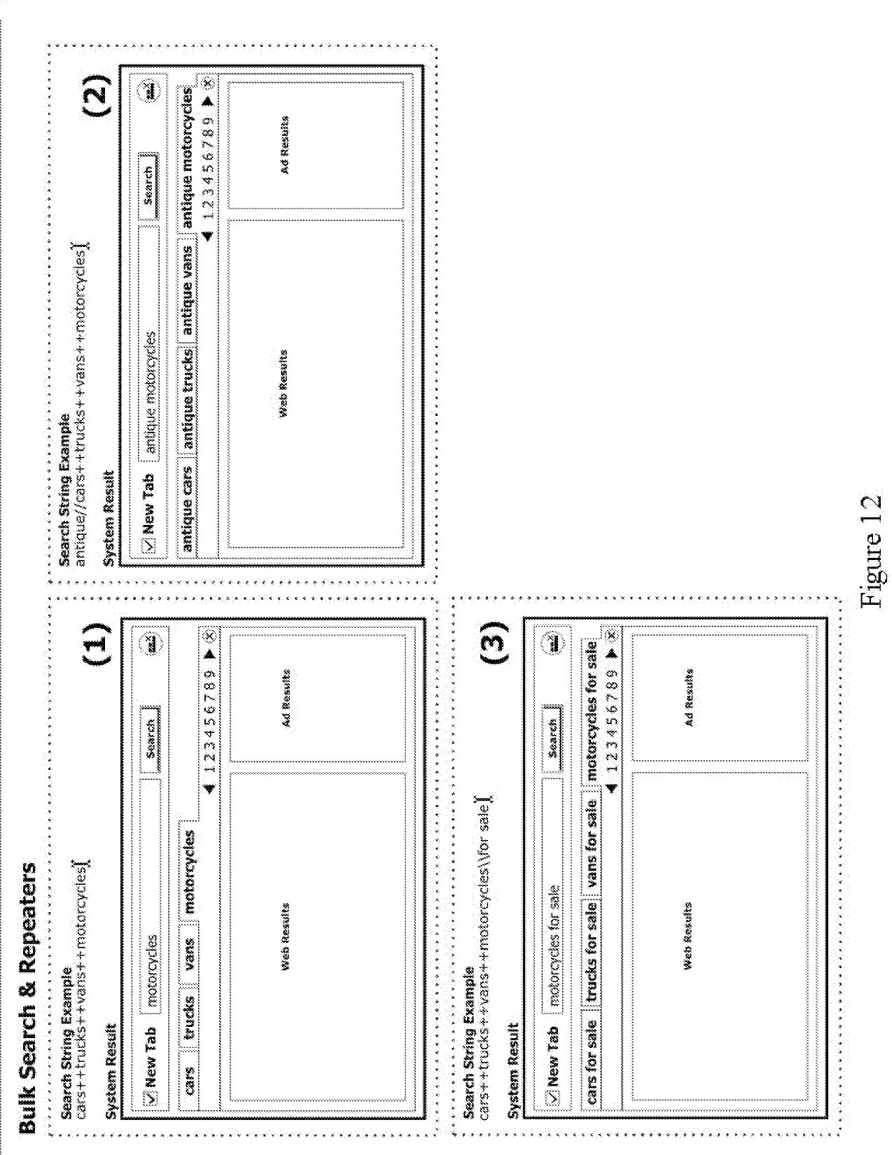

The bulk search trigger allows a user to simultaneously search for any number of items. The system recognizes the “++” (double plus sign) as a separator which in turn opens a tab for each search term as shown in FIG. 12.

### Repeaters

As shown in FIG. 12, Repeat triggers work hand and hand with the bulk search trigger. It reduces the number of keystrokes required when conducting and refining bulk searches. The system recognizes “//” (double forward slash) as the first term repeater and “\\” (double back slash) as the last term repeater.

### RSS Feed Source Search

This trigger is for searching for RSS feed sources only. It allows a user to search for feeds only on any given topic in the same way the system displays standard web results. The system recognizes “.))” (period, then double close bracket) at the beginning of the search string as the trigger to search feed sources.

### RSS Feed Reader

This trigger allows a user to open the RSS feed directly into it's own tab. The feed is displayed similar to the web results and is automatically updated when the tab is clicked or accessed. The system 1 recognizes “))” (double close bracket) at the end of the RSS feed's URL or quick term.

### Shortcuts

This is a customizable trigger that allows users to use predefined searches or search templates. The system recognizes “;;name” (double semi colon and the shortcut name) and can be used either by itself or with a search term.

### QuickTags

This simply allows users to use clickable links of the desired shortcut triggers versus having to use keystrokes.

### Independent Tab Page Jumps

This enables each tab to be on a different page with each set of results. This allows users to sift though pages of results on each tab with out effecting the page placement of each open tab.

### Save/Open Tabbed Results

This allows users to save their search so that it can be continued at another time or from another place. Users can group tabs together to be saved /opened in a single click or they can selectively check which tabs they wish to open/save.

### Page Place Holding

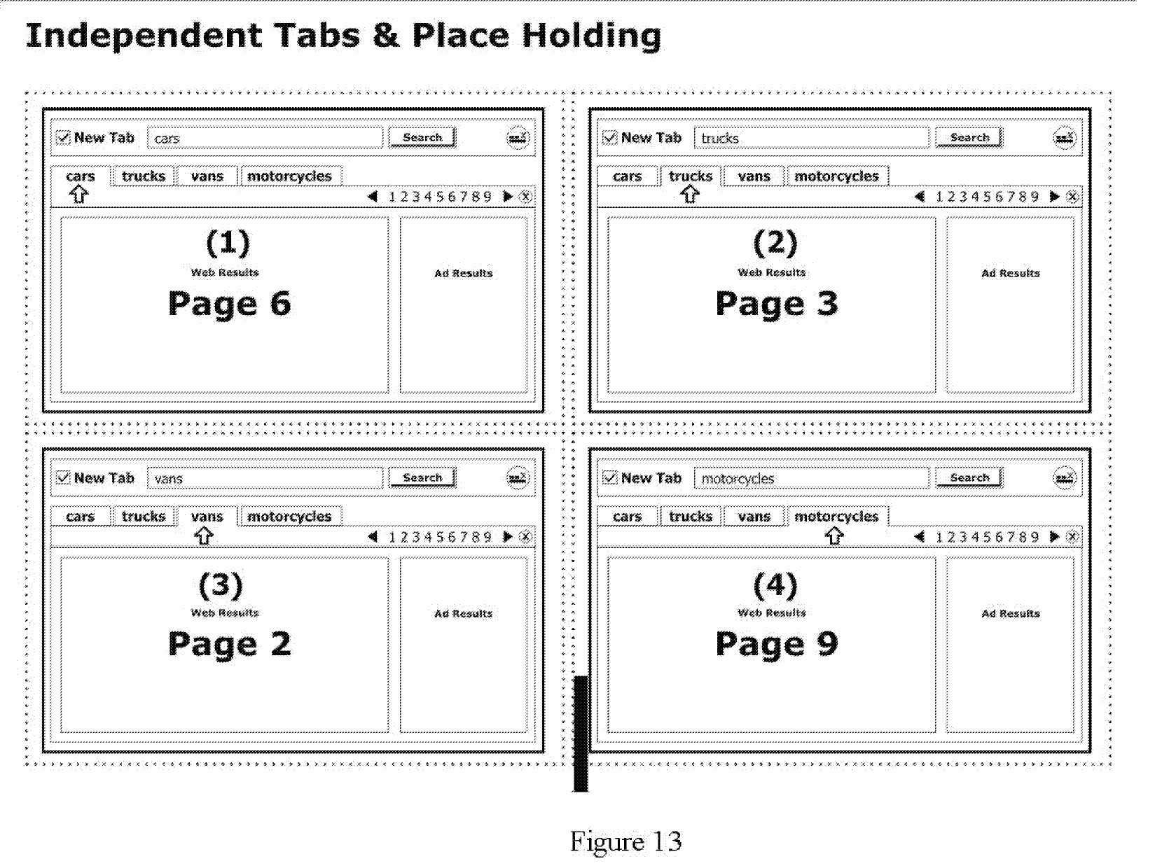

When a user clicks a result, leaves and returns, or saves their results the system will automatically return the user to where they had left off rather than having them start their search all over again as shown in FIG. 13.

### Shortlist Results

This allows users to create a result shortlist for any particular search term for the results they see as relevant or worth checking out.

### System Toolbar & Remote Mode

System Toolbar is a browser plug-in for both Internet Explorer and FireFox. It allows a user to quickly search or access System 1 without being on the website 100. If a user 10 is using the System Toolbar they can enable “Remote Mode” which allows the user to turn off the site search bar and header graphic so that the page is dedicated to search or RSS results.

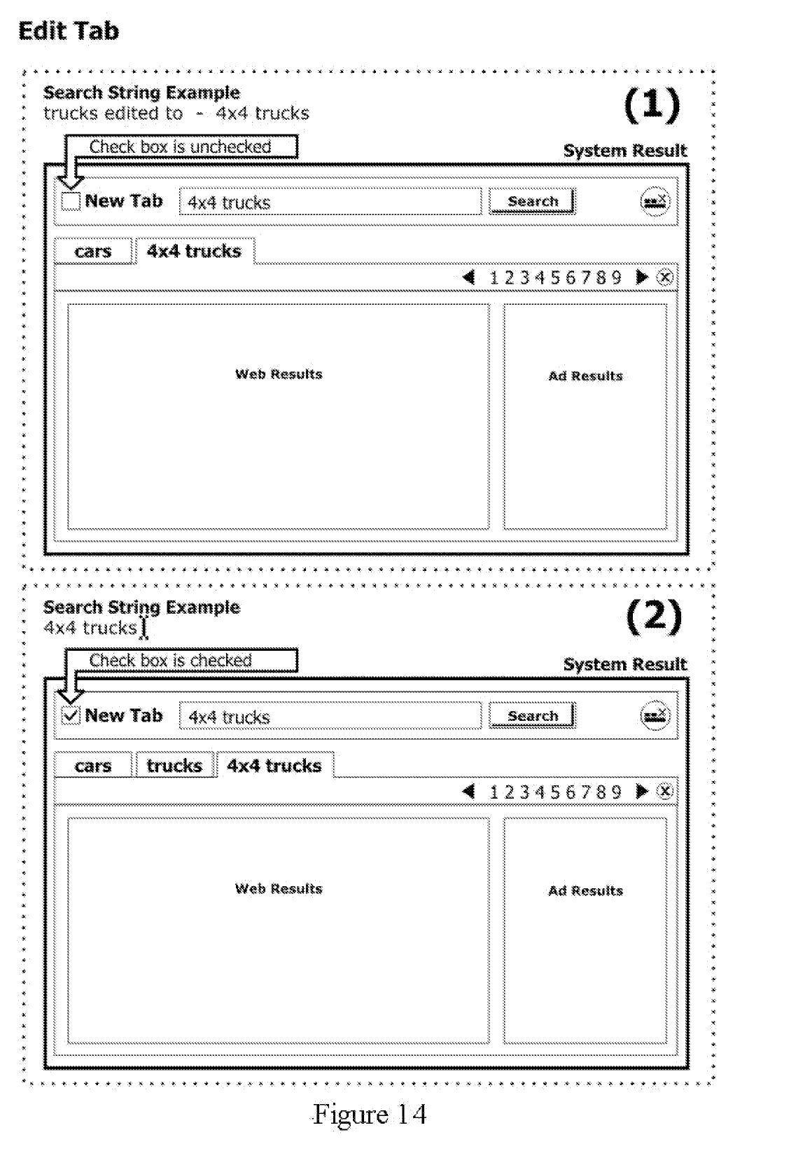

FIG. 14 displays a search string example.

The system 1 allows users 10 to save their preferences, searches and shortlists The system 1 will have standard Function Triggers. The suggested Function Triggers are:
“Bulk Search=++”;
“Open RSS Feed=))”;
“RSS Feed Sources=.))”;
“First Term Repeater=//”;
“Last Term Repeater=\\”; and
“TWERQ Help Search=??”.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An internet search engine system comprising: having multiple searches which can be conducted simultaneously using both keywords and function triggers with each set of results displaying in their own tab.

2. The system according to claim 1 wherein each tab of results can be quickly flipped through for viewing and comparison.

3. The system according to claim 2 wherein each tab can be closed individually and all at once.

4. The system according to claim 1 wherein each tab can be closed individually and all at once.

5. The system according to claim 1 wherein the first tab is for the first search.

6. The system according to claim 1 wherein having a side scroller appear once the number of open tabs is greater than 8.

7. The system according to claim 1 wherein the system would have Function Triggers.

8. The system according to claim 7 wherein the system would have a Bulk Search Function.

9. The system according to claim 7 wherein the system would have a Repeater Search Function.

10. The system according to claim 7 wherein the system would have a Relevance Score Result Feed Source Search Function.

11. The system according to claim 7 wherein the system would have a Relevance Score Result Feed Reader.

12. The system according to claim 7 wherein the system would have a Relevance Score Result Feed Reader.

13. The system according to claim 7 wherein the system would have a customizable trigger that allows users to use predefined searches or search templates.

14. The system according to claim 13 wherein the system would have clickable links for shortcut triggers.

15. The system according to claim 1 wherein the system allows users to save their search.

16. The system according to claim 1 wherein when a user clicks a result, leaves and returns the system will automatically return the user to where they had left off.

17. The system according to claim 1 wherein the system has a browser plug-in Toolbar.

18. The system according to claim 1 wherein the system uses a Content Relevance Score Result.

19. The system according to claim 1 wherein users will score a search results using a rating system.

20. An internet search engine system comprising: having multiple searches which can be conducted simultaneously using both keywords and function triggers with each set of results displaying in their own tab, where each tab of results can be quickly flipped through for viewing and comparison, where each tab can be closed individually and all at once, where a side scroller appears once the number of open tabs is greater than 8, where the system would have Function Triggers which includes one or more of the following set a Bulk Search Function, a Repeater Search Function, a Relevance Score Result Feed Source Search Function, a Relevance Score Result Feed Reader Function or a Relevance Score Result Feed Reader, where the system would have a customizable trigger that allows users to use predefined searches or search templates, where the system would have clickable links for shortcut triggers, where the system allows users to save their search and where when a user clicks a result, leaves and returns the system will automatically return the user to where they had left off.
